(19) United States
(12) Patent Application Publication
(10) Pub. No.: US 2026/0204559 A1
(43) Pub. Date: Jul. 16, 2026

(54) LITHIUM NICKEL-BASED COMPOSITE OXIDE AS A POSITIVE ELECTRODE ACTIVE MATERIAL FOR SULFIDE SOLID-STATE RECHARGEABLE BATTERIES

(71) Applicant: Umicore, Brussels (BE)

(72) Inventors: Shinichi KUMAKURA, Olen (BE); TaeHyeon YANG, Cheonan Chungcheongnam-do (KR); Esther BREUGELMANS, Olen (BE)

(21) Appl. No.: 19/138,265

(22) PCT Filed: Dec. 14, 2023
(86) PCT No.: PCT/EP2023/085836

§ 371 Date: Jun. 12, 2025

(30) Foreign Application Priority Data
Dec. 16, 2022 (EP) 22214068.3

(51) Int. Cl. H01M 4/525; H01M 4/02; H01M 4/04; H01M 10/0562

(52) U.S. Cl. CPC H01M 4/525; H01M 4/04; H01M 10/0562; H01M 2004/028; H01M 2220/20; H01M 2300/0065

(57) ABSTRACT

The present invention relates a positive electrode active material for solid state batteries comprising Li, M′ and O, wherein M′ comprises Si and/or Zr. The present inventors have surprisingly found that the positive electrode active material of the invention increases the cycling efficiency of the battery, in particular a sulfide solid-state battery. Moreover, these coated positive electrode active material display a high first discharge capacity.

### TECHNICAL FIELD

The present invention relates to a positive electrode active material for solid state batteries comprising Li, M′ and O, wherein M′ comprises Si and/or Zr. This invention also relates to a method for manufacturing said positive electrode active material, the solid-state battery comprising said positive electrode active material and the use of said solid-state battery.

### BACKGROUND

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to the high energy density and a high reference electrode potential.

During the charging process of a secondary battery, lithium ions are removed from the cathode, transported through the electrolyte and are inserted into the anode while electrons are removed from the cathode and injected into the anode through an external circuit (charger). During the use or discharge of a secondary battery lithium ions are removed from the anode, transported through the electrolyte, and are inserted into the cathode, while electrons flow through an external circuit to provide electric work.

Commonly used cathode active materials are lithium transition metal oxides. During the charging and/or discharging of the lithium battery, the delithiated cathode active material can slowly react with the non-aqueous electrolyte or the solid electrolyte leading to a gradual degradation of the electrochemical performance of lithium batteries using such cathode active materials.

It has been demonstrated that coating of the cathode active material with metals, such as B or Zr, (i.e. applying a thin surface layer of the metal on the cathode active material resulting in an increased amount of said metals in the surface layer) results in a cathode active material exhibiting a higher stability as compared to their counterparts devoid of coating layer.

Strauss et al (ACS Appl. Mater. Interfaces 2020, 12, 51, 57146-57154) contemplates a lithium nickel-based oxide positive electrode active material comprising a Zr compound obtained after mixing the positive electrode active material comprising Li, M′, and O, wherein M′ is Ni_{0.6}Co_{0.2}Mn_{0.2}, with Zr-ethoxide in an ethanol solvent.

U.S. Pat. No. 10,164,249 B2 discloses a Zr and F doped positive electrode active material mixed with an orthosilicate ester solution in ethanol, followed by heat-treatment at 160° C. to remove the ethanol and sintering at 850° C. to afford the positive electrode active material.

However, there remains a need to provide a positive electrode active material comprising Si and/or Zr to improve the first discharge capacity and/or the cycling efficiency of the resulting battery.

It is an object of the present invention to provide a positive electrode active material comprising Si and/or Zr to improve the first discharge capacity and/or the cycling efficiency of the resulting battery.

It is another object of the present invention to provide a method for manufacturing said positive electrode active material.

It is another object of the present invention to provide a battery comprising said positive electrode active material.

It is another object of the present invention to provide a use of said battery.

### SUMMARY OF THE INVENTION

In a first aspect an object of the invention is achieved by providing a positive electrode active material for solid state batteries comprising Li, M′, and oxygen, wherein M′ comprises:
Ni in a content x, wherein 50.0≤x≤95.0 mol %, relative to M′,
Mn in a content y, wherein 0.0≤y≤30.0 mol %, relative to M′,
Co in a content z, wherein 0.0≤z≤30.0 mol %, relative to M′,
Si in a content a, wherein 0.01≤a≤1.5 mol %, relative to M′,
Zr in a content b, wherein 0.0≤b≤1.5 mol %, relative to M′,
D in a content d, wherein D is an element other than Li, Ni, Mn, Co, Si, Zr and oxygen; wherein 0.0≤d≤2.0 mol %, relative to M′, and,
wherein x, y, z, a, b, and d are measured by ICP-OES,
wherein x+y+z+a+b+d is 100.0 mol %,
   wherein the positive electrode active material has an enriched amount of Si and/or Zr in the surface layer.

Worded differently, the positive electrode active material of the invention has a surface layer comprising Si and/or Zr.

The present inventors have surprisingly found that the positive electrode active material of the invention increases the cycling efficiency of the battery, in particular a sulfide solid-state battery, as demonstrated in the appended examples. Moreover, these coated positive electrode active material display a high first discharge capacity.

Preferably, the coated positive electrode active material comprising Si and Zr outperforms the corresponding coated positive electrode material comprising Zr and not Si in terms of first charge discharge capacity and cycling efficiency.

Preferably, the coated positive electrode active material comprising Si and Zr outperforms the corresponding coated positive electrode material comprising Si and not Zr in terms of first charge discharge capacity and cycling efficiency. Moreover, the coated positive electrode active material comprising Si and Zr outperforms the corresponding coated positive electrode material comprising Zr and not Si in terms of first charge discharge capacity and cycling efficiency.

The positive electrode active material of the present invention comprising Si and Zr in a specific amount in the surface layer has the advantage that a higher discharge capacity and/or higher cycling efficiency of the resulting battery is obtained as compared to positive electrode active material comprising Zr in the same specific amount. This has the advantage that part of the Zr in the surface layer can be replaced with Si, which is a more abundant and cheaper metal than Zr, to afford a battery having the same or even higher discharge capacities and/or the same or higher cycling efficiencies.

Preferably, the coated positive electrode active material comprising Si and not Zr outperforms the corresponding coated positive electrode material comprising Zr and not Si in terms of first charge discharge capacity and cycling efficiency.

The positive electrode active material of the present invention comprising Si in a specific amount in the surface layer (and not Zr) has the advantage that a higher discharge capacity and/or higher cycling efficiency of the resulting battery is obtained as compared to positive electrode active material comprising Zr in the same specific amount. This has the advantage that the whole of the Zr in the surface layer can be replaced with Si, which is a more abundant and cheaper metal than Zr, to afford a battery having the same or even higher discharge capacities and/or the same or higher cycling efficiencies.

Furthermore, the present inventors have found that the positive electrode active material of the invention comprising Si or comprising Si and Zr improves the storage stability. In particular a decreased uptake of water and carbon (or carbon dioxide) is observed by applying a surface layer of Si on the positive electrode active material. Without wishing to be bound by any theory, the present inventors believe that the surface layer of Si acts as a hydrophobic surface layer, which suppresses the formation of residual lithium compounds such as Li₂CO₃, which are formed due to reaction between lithium present in the positive electrode active material and water and carbon in the surrounding air, because the hydrophobic surface inhibits contact between water and the positive electrode active material.

In a further aspect the invention provides a method for manufacturing said positive electrode active material.

In a further aspect the invention provides a battery comprising said positive electrode active material.

In a further aspect the invention provides a use of said battery.

### FIGURES

FIG. 1. XPS peaks of Si and Zr for EX1.1

### DETAILED DESCRIPTION OF THE INVENTION

In the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein and in the claims refers to a cell or a battery that includes only solid or substantially solid-state components such as solid electrodes (e.g. anode and cathode) and a solid electrolyte.

The term “a positive electrode active material” (also known as cathode active material) as used herein and in the claims is defined as a material which is electrochemically active in a positive electrode or cathode. By active material, it must be understood to be a material capable to capture and release Li ions when subjected to a voltage change over a predetermined period of time.

The term “a positive electrode” as used herein is defined as a material comprising a positive electrode active material in addition to other components which are not electrochemically active, in particular conductivity agents such as carbon black or binders such as PVDF.

The term “slurry” as used herein and in the claims refers to a mixture, premixture and/or admixture of solid particles suspended in a liquid, such as water, alcohol or combinations thereof. When using the term “slurry” the solid particles are not dissolved or not completely dissolved in the liquid. For example, a slurry of a lithium transition metal-based oxide compound is a suspension of the particles constituting the lithium transition metal-based oxide compound in a liquid. Worded differently, the particles constituting the lithium transition metal-based oxide compound are not dissolved or not completely dissolved in the liquid.

In the context of the present invention the terms “solid” and “liquid” shall be considered to be a solid and liquid in standard conditions for temperature and pressure as defined by the IUPAC, unless defined otherwise. Hereby the boiling point and the melting point shall be considered to be the boiling point and the melting point at standard atmospheric pressure, i.e. at 101325 Pa.

### Positive Electrode Active Material

In a first aspect, the present invention concerns a positive electrode active material for solid state batteries comprising Li, M′, and oxygen, wherein M′ comprises:
Ni in a content x, wherein 50.0≤x≤95.0 mol %, relative to M′,
Mn in a content y, wherein 0.0≤y≤30.0 mol %, relative to M′,
Co in a content z, wherein 0.0≤z≤30.0 mol %, relative to M′,
Si in a content a, wherein 0.01≤a≤1.5 mol %, relative to M′,
Zr in a content b, wherein 0.0≤b≤1.5 mol %, relative to M′,
D in a content d, wherein D is an element other than Li, Ni, Mn, Co, Si, Zr and oxygen; wherein 0.0≤d≤2.0 mol %, relative to M′, and,
wherein x, y, z, a, b, and d are measured by ICP-OES,
wherein x+y+z+a+b+d is 100.0 mol %,
   wherein the positive electrode active material has a Si content Si_{A} defined as a/(x+y+z+a+b), wherein the positive electrode active material has a Si content Si_{B}, wherein Si_{B} is expressed as molar fraction Si compared to the sum of molar fractions of Ni, Mn, Co, Si, and Zr, as measured by XPS analysis, wherein the ratio Si_{B}/Si_{A}>50.0.

A preferred embodiment is the positive electrode active material of the invention, wherein Ni is in a content x≥55.0 mol %, preferably x≥58.0 mol %, more preferably x>60.0 mol %, relative to M′. In a preferred embodiment Ni is in a content x≤90.0 mol % preferably x≤88 mol %, more preferably x≤85.0 mol %, relative to M′. A more preferred embodiment is the positive electrode active material of the invention, wherein Ni is in a content x between 55.0 mol %≤x≤90.0 mol %, preferably 58.0 mol %≤x≤88.0 mol %, more preferably 60.0 mol %≤x≤85.0 mol %, relative to M′.

A certain preferred embodiment is the positive electrode active material of the invention, wherein Ni is in a content x≥55.0 mol %, preferably x≥58.0 mol %, more preferably x≥60.0 mol %, relative to M′. In a certain preferred embodiment Ni is in a content x≤75.0 mol % preferably x≤72 mol %, more preferably x≤70.0 mol %, relative to M′. A more certain preferred embodiment is the positive electrode active material of the invention, wherein Ni is in a content x between 55.0 mol %≤x≤75.0 mol %, preferably 58.0 mol %≤x≤72.0 mol %, more preferably 60.0 mol %≤x≤70.0 mol %, relative to M′.

A certain preferred embodiment is the positive electrode active material of the invention, wherein Ni is in a content x≥75.0 mol %, preferably x≥78.0 mol %, more preferably x≥80.0 mol %, relative to M′. In a certain preferred embodiment Ni is in a content x≤92.0 mol % preferably x≤90 mol %, more preferably x≤88.0 mol %, relative to M′. A more certain preferred embodiment is the positive electrode active material of the invention, wherein Ni is in a content x between 75.0 mol %≤x≤92.0 mol %, preferably 78.0 mol %≤x≤90.0 mol %, more preferably 80.0 mol %≤x≤88.0 mol %, relative to M′.

As appreciated by the skilled person the amount of Li and M′, preferably Li, Ni, Mn, Co, D, Si and Zr, in the positive electrode active material is measured by Inductively Coupled Plasma Optical Emission Spectroscopy (ICP-OES). For example, but not limiting to the invention, an Agilent ICP 720-ES is used in the ICP-OES analysis.

A preferred embodiment is the positive electrode active material of the invention, wherein Mn is in a content y>0.0 mol %, preferably y≥5.0 mol %, more preferably y≥10.0 mol %, relative to M′. In a preferred embodiment the content is y≤30.0 mol %, preferably y≤25.0 mol %, and more preferably y≤20.0 mol %, relative to M′. In a preferred embodiment Mn is in a content 0.0 mol %<y≤30.0 mol %, preferably 5.0 mol %≤y≤25.0 mol %, more preferably 10.0 mol %≤y≤20.0 mol %, relative to M′.

A certain preferred embodiment is the positive electrode active material of the invention, wherein Mn is in a content y>0.0 mol %, preferably y≥1.0 mol %, more preferably y≥2.0 mol %, relative to M′. In a preferred embodiment the content is y≤20.0 mol %, preferably y≤15.0 mol %, and more preferably y≤10.0 mol %, relative to M′. In a preferred embodiment Mn is in a content 0.0 mol %<y≤20.0 mol %, preferably 1.0 mol %≤y≤15.0 mol %, more preferably 2.0 mol %≤y≤10.0 mol %, relative to M′.

A preferred embodiment is the positive electrode active material of the invention, wherein Co is in a content z>0.0 mol %, preferably z≥5.0 mol %, more preferably z≥10.0 mol %, relative to M′. In a preferred embodiment the content is z≤30.0 mol %, preferably z≤25.0 mol %, and more preferably z≤20.0 mol %, relative to M′. In a preferred embodiment Co is in a content 0.0 mol %<z≤30.0 mol %, preferably 5.0 mol %≤z≤25.0 mol %, more preferably 10.0 mol %≤z≤20.0 mol %, relative to M′.

A certain preferred embodiment is the positive electrode active material of the invention, wherein Co is in a content z>0.0 mol %, preferably z≥1.0 mol %, more preferably z≥2.0 mol %, relative to M′. In a preferred embodiment the content is z≤20.0 mol %, preferably z≤15.0 mol %, and more preferably z≤10.0 mol %, relative to M′. In a preferred embodiment Co is in a content 0.0 mol %<z≤20.0 mol %, preferably 1.0 mol %≤z≤15.0 mol %, more preferably 2.0 mol %≤z≤10.0 mol %, relative to M′.

As is known to the skilled person, the positive electrode active material of the invention can comprise impurities or be doped or coated resulting in an overall positive electrode active material comprising one or more elements other than Li, Ni, Mn, Co, Zr, Si and O, which is reflected in the parameter “D” used herein. A preferred embodiment is the positive electrode active material according to the invention comprising D, wherein D is at least one element selected from the group consisting of Al, B, Ba, Ca, Ce, Cr, Fe, La, Mg, Mo, Nb, S, Sr, Ti, V, W, Y, and Zn; preferably Al, B, Ti, Cr, Nb, S, Y, and W; more preferably Al, B, Ti, Nb, and W.

A preferred embodiment is the positive electrode active material according to the invention, wherein D is in a content d>0.0 mol %, preferably d≥0.25 mol %, more preferably d≥0.5 mol %, relative M′. In a preferred embodiment the content d≤1.75 mol %, preferably d≤1.5 mol %, more preferably d≤1.25 mol %, relative to M′. In a preferred embodiment the content d is 0.0 mol %<d≤1.75 mol %, preferably 0.25 mol %≤d≤1.5 mol %, more preferably 0.5 mol %≤d≤1.25 mol %, relative to M′.

In certain preferred embodiments the positive electrode active material is according to the invention, wherein d=0.0 mol %, relative to M′.

A preferred embodiment is the positive electrode active material according to the invention, wherein Si is in a content a>0.03 mol %, preferably a≥0.05 mol %, more preferably a≥0.07 mol %, relative M′. In a preferred embodiment the content a≤1.0 mol %, preferably a≤0.75 mol %, more preferably a≤0.5 mol %, relative to M′. In a preferred embodiment the content a is 0.03 mol %<a≤1.0 mol %, preferably 0.05 mol %≤a≤0.75 mol %, more preferably 0.07 mol %≤a≤0.5 mol %, relative to M′.

In certain preferred embodiments the positive electrode active material is according to the invention, wherein b>0.0 mol %, relative to M′.

A certain highly preferred embodiment is the positive electrode active material according to the invention, wherein Zr is in a content b>0.0 mol %, preferably b≥0.05 mol %, more preferably b>0.1 mol %, relative M′. In a preferred embodiment the content b≤1.0 mol %, preferably b≤0.5 mol %, more preferably b≤0.25 mol %, relative to M′. In a preferred embodiment the content b is 0.0 mol %<b≤1.0 mol %, preferably 0.05 mol %≤b≤0.5 mol %, more preferably 0.1 mol %≤b≤0.25 mol %, relative to M′.

In certain preferred embodiments the positive electrode active material is according to the invention, wherein b=0.0 mol %, relative to M′.

In a preferred embodiment the positive electrode active material consist of Li, M′ and O.

In certain preferred embodiments the positive electrode active material is according to the invention,
wherein Si is in a content 0.03 mol %<a≤1.0 mol %, preferably 0.05 mol %≤a≤0.75 mol %, more preferably 0.07 mol %≤a≤0.5 mol %, relative to M′, and
wherein b=0.0 mol %, relative to M′.

A preferred embodiment is the positive electrode active material of the invention having a carbon content of higher than 0.020 wt. % by total weight of the positive electrode active material, preferably a carbon content higher than 0.022 wt. %, more preferably a carbon content higher than 0.025 wt. % by total weight of the positive electrode active material. A preferred embodiment is the positive electrode active material of the invention having a carbon content of less than 0.070 wt. % by total weight of the positive electrode active material, preferably a carbon content less than 0.060 wt. %, more preferably a carbon content less than 0.050 wt. % by total weight of the positive electrode active material. A preferred embodiment is the positive electrode active material of the invention having a carbon content in the range of 0.020 wt. % and 0.070 wt. % by total weight of the positive electrode active material, preferably a carbon content in the range of 0.022 wt. % and 0.060 wt. %, more preferably a carbon content in the range of 0.025 wt. % and 0.050 wt. % by total weight of the positive electrode active material. As appreciated by the skilled person the carbon content of the positive electrode active material of the invention is measured with a carbon analyzer. For example, but not limiting to the invention, a Horiba Emia-Expert carbon/sulfur analyzer can be used to measure the carbon content.

A preferred embodiment is the positive electrode active material of the invention having a Li/M′ ratio, preferably a Li/(Ni+Mn+Co) ratio, >0.90, preferably >0.92, more preferably >0.95. A preferred embodiment is the positive electrode active material of the invention having a Li/M′ ratio, preferably a Li/(Ni+Mn+Co) ratio, <1.10, preferably <1.08, more preferably <1.05. A preferred embodiment is the positive electrode active material of the invention having a Li/M′ ratio, preferably a Li/(Ni+Mn+Co) ratio, in the range of 0.90-1.10, preferably in the range of 0.92-1.08, more preferably in the range of 0.95-1.05. As appreciated by the skilled person the Li/M′ ratio, preferably the Li/(Ni+Mn+Co) ratio, is a molar ratio (mol/mol).

A highly preferred embodiment is the positive electrode active material according to the invention having a formula (I):

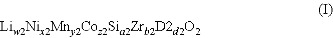

wherein 0.90≤w2≤1.10, preferably 0.92≤w2≤1.08, more preferably 0.95≤w2≤1.05;
wherein 0.55≤x2≤0.90, preferably 0.58≤x2≤0.88, more preferably 0.60≤x2≤0.85;
wherein 0.0<y2≤0.30, preferably 0.05≤y2≤0.25, more preferably 0.10≤y2≤0.20;
wherein 0.0<z2≤0.30, preferably 0.05≤z2≤0.25, more preferably 0.10≤z2≤0.20;
wherein 0.0003≤a2≤0.01, preferably 0.0005≤a2≤0.0075, more preferably 0.0007≤a2≤0.005;
wherein 0.0<b2≤0.01, preferably 0.0005≤b2≤0.005, more preferably 0.0001≤b2≤0.0025;
wherein 0.0≤d2≤0.0175, preferably 0.0≤d2≤0.015, more preferably 0.0≤d2≤0.0125, most preferably d2 is about 0.0;
wherein x2+y2+z2+a2+b2+d2=1.00; and
wherein D2 is an element other than Li, O, Ni, Co, Mn, Z and Si.

In certain preferred embodiment 0.55≤x2≤0.75, preferably 0.58≤x2≤0.72, more preferably 0.60≤x2≤0.70;

As is known to the skilled person, the positive electrode active material of the invention can comprise impurities or be doped or coated resulting in an overall positive electrode active material comprising one or more elements other than Li, Ni, Mn, Co, Zr, Si and O, which is reflected in the parameter “D2” used herein. A preferred embodiment is the positive electrode active material according to the invention comprising D2, wherein D2 is at least one element selected from the group consisting of Al, B, Ba, Ca, Ce, Cr, Fe, La, Mg, Mo, Nb, S, Sr, Ti, V, W, Y, and Zn; preferably Al, B, Ti, Cr, Nb, S, Y, and W; more preferably Al, B, Ti, Nb, and W.

### Surface Layer

The present invention provides the positive electrode active material according to the invention, wherein the positive electrode active material has a Si content Si_{A} defined as a/(x+y+z+a+b), wherein the positive electrode active material has a Si content Si_{B}, wherein Si_{B} is expressed as molar fraction Si compared to the sum of molar fractions of Ni, Mn, Co, Si, and Zr, as measured by XPS analysis, wherein the ratio Si_{B}/Si_{A}>50.0.

A more preferred embodiment concerns the positive electrode active material according to the invention, wherein the ratio Si_{B}/Si_{A}>100.0, preferably wherein the ratio Si_{B}/Si_{A}>200.0, more preferably wherein the ratio Si_{B}/Si_{A}>250.0. A more preferred embodiment concerns the positive electrode active material according to the invention, wherein the ratio Si_{B}/Si_{A}<1000.0, preferably wherein the ratio Si_{B}/Si_{A}<600.0, more preferably wherein the ratio Si_{B}/Si_{A}<400.0. A more preferred embodiment concerns the positive electrode active material according to the invention, wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0.

Certain preferred embodiments concern the positive electrode active material according to the invention, wherein the ratio Si_{B}/Si_{A}>300.0. Certain preferred embodiments concern the positive electrode active material according to the invention, wherein the ratio Si_{B}/Si_{A}<400.0. Certain preferred embodiments concern the positive electrode active material according to the invention, wherein the ratio Si_{B}/Si_{A} is in the range of 300.0 and 400.0.

In the context of the present invention, Si_{B} is the molar fraction of Si measured in a region of a particle of the positive electrode active material according to invention defined between a first point of an external edge of said particle and a second point at a distance from said first point. Said distance separating said first to said second point being equal to a penetration depth of said XPS, said penetration depth D′ being comprised between 1.0 to 10.0 nm. In particular, the penetration depth is the distance along an axis perpendicular to a virtual line tangent to said external edge and passing trough said first point.

The external edge of the particle is, in the framework of this invention, the boundary or external limit distinguishing the particle from its external environment. Therefore, XPS analysis provides atomic content of elements in an uppermost layer of a particle with a penetration 30 depth of about 10.0 nm from an outer boundary of the particle. The outer boundary of the particle is also referred to as “surface”. For example, but not limiting to the invention, XPS analysis is carried out with a Thermo K-α+ spectrometer (Thermo Scientific).

In the framework of the present invention, at % signifies atomic percentage. The at % or “atomic percent” of a given element expression of a concentration means how many percent of all atoms in the concerned compound are atoms of said element. Further in the framework of the present invention the designation at % is equivalent to mol % or “molar percent”.

As appreciated by the skilled person the defined ratio Si_{B}/Si_{A} refers to the positive electrode active material of the invention having an enriched amount of Si in the surface layer of the positive electrode active material. The surface layer of the positive electrode active material is 1 to 10 nm of the uppermost part of the positive electrode active material. Worded differently, the positive electrode active material of the invention comprises a surface layer of Si. For example, but not limiting to the invention, an compound of Si present in the surface layer of the positive electrode active material is Li₂SiO₃.

In the context of the present invention the positive electrode active material may comprise a first surface layer comprising D, wherein D is at least one element selected from the group consisting of Al, B, Ba, Ca, Ce, Cr, Fe, La, Mg, Mo, Nb, S, Sr, Ti, V, W, Y, and Zn; preferably Al, B, Ti, Cr, Nb, S, Y, and W; more preferably Al, B, Ti, Nb, and W, wherein the surface layer of Si may be placed on the first surface layer and/or the first surface layer may be placed on the surface layer of Si and/or the positive electrode active layer may comprise a mixed surface layer comprising the surface layer of Si and the first surface layer.

A preferred embodiment concerns the positive electrode active material according to the invention, wherein the positive electrode active material has a Zr content Zr^{A} defined as b/(x+y+z+a+b), wherein the positive electrode active material has a Zr content Zr_{B}, wherein Zr_{B} is expressed as molar fraction Zr compared to the sum of molar fractions of Ni, Mn, Co, Si, and Zr, as measured by XPS analysis, wherein the ratio Zr_{B}/Zr_{A}>50.0.

A more preferred embodiment concerns the positive electrode active material according to the invention, wherein the ratio Zr_{B}/Zr_{A}>75.0, preferably wherein the ratio Zr_{B}/Zr_{A}>100.0, more preferably wherein the ratio Zr_{B}/Zr_{A}>150.0. A more preferred embodiment concerns the positive electrode active material according to the invention, wherein the ratio Zr_{B}/Zr_{A}<1000.0, preferably wherein the ratio Zr_{B}/Zr_{A}<600.0, more preferably wherein the ratio Zr_{B}/Zr_{A}<400.0. A more preferred embodiment concerns the positive electrode active material according to the invention, wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0.

Certain preferred embodiments concern the positive electrode active material according to the invention, wherein the ratio Zr_{B}/Zr_{A}>275.0. Certain preferred embodiments concern the positive electrode active material according to the invention, wherein the ratio Zr_{B}/Zr_{A}<350.0. Certain preferred embodiments concern the positive electrode active material according to the invention, wherein the ratio Zr_{B}/Zr_{A} is in the range of 275.0 and 350.0.

In the context of the present invention, Zr_{B} is the molar fraction of Zr measured in a region of a particle of the positive electrode active material according to invention defined between a first point of an external edge of said particle and a second point at a distance from said first point. Said distance separating said first to said second point being equal to a penetration depth of said XPS, said penetration depth D′ being comprised between 1.0 to 10.0 nm. In particular, the penetration depth is the distance along an axis perpendicular to a virtual line tangent to said external edge and passing trough said first point.

As appreciated by the skilled person the defined ratio Zr_{B}/Zr_{A} refers to the positive electrode active material of the invention having an enriched amount of Zr in the surface layer of the positive electrode active material. The surface layer of the positive electrode active material is 1 to 10 nm of the uppermost part of the positive electrode active material. Worded differently, the positive electrode active material of the invention comprises a surface layer of Zr. For example, but not limiting to the invention, an compound of Zr present in the surface layer of the positive electrode active material is Li₂ZrO₃.

In the context of the present invention the positive electrode active material may comprise a second surface layer comprising D, wherein D is at least one element selected from the group consisting of of Al, B, Ba, Ca, Ce, Cr, Fe, La, Mg, Mo, Nb, S, Sr, Ti, V, W, Y, and Zn; preferably Al, B, Ti, Cr, Nb, S, Y, and W; more preferably Al, B, Ti, Nb, and W, wherein the surface layer of Zr may be placed on the second surface layer and/or the second surface layer may be placed on the surface layer of Zr and/or the positive electrode active layer may comprise a mixed surface layer comprising the surface layer of Zr and the second surface layer.

A certain preferred embodiment concerns the positive electrode active material according to the invention, wherein the positive electrode active material has
a Si content Si_{A} defined as a/(x+y+z+a+b), wherein the positive electrode active material has a Si content Si_{B}, wherein Si_{B} is expressed as molar fraction Si compared to the sum of molar fractions of Ni, Mn, Co, Si, and Zr, as measured by XPS analysis, wherein the ratio Si_{B}/Si_{A}>50.0, preferably wherein the ratio Si_{B}/Si_{A}>100; and
a Zr content Zr_{A} defined as b/(x+y+z+a+b), wherein the positive electrode active material has a Zr content Zr_{B}, wherein Zr_{B} is expressed as molar fraction Zr compared to the sum of molar fractions of Ni, Mn, Co, Si, and Zr, as measured by XPS analysis, wherein the ratio Zr_{B}/Zr_{A}>50.0. preferably wherein the ratio Zr_{B}/Zr_{A}>100.

A more certain preferred embodiment concerns the positive electrode active material according to the invention,
wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0; and
wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0.

A certain preferred embodiment concerns the positive electrode active material according to the invention,
wherein the ratio Si_{B}/Si_{A} is in the range of 300.0 and 400.0, and,
wherein the ratio Zr_{B}/Zr_{A} is in the range of 275.0 and 350.0.

As appreciated by the skilled person the defined ratio Zr_{B}/Zr_{A} and Si_{B}/Si_{A} refers to the positive electrode active material of the invention having an enriched amount of Zr and Si in the surface layer of the positive electrode active material. The surface layer of the positive electrode active material is 1 to 10 nm of the uppermost part of the positive electrode active material. Worded differently, the positive electrode active material of the invention comprises a surface layer of Zr and Si. For example, but not limiting to the invention, an compound of Si and Zr present in the surface layer of the positive electrode active material is Li₂Si_{0.5}Zr_{0.5}O₃.

In the context of the present invention the positive electrode active material may comprise a third surface layer comprising D, wherein D is at least one element selected from the group consisting of of Al, B, Ba, Ca, Ce, Cr, Fe, La, Mg, Mo, Nb, S, Sr, Ti, V, W, Y, and Zn; preferably Al, B, Ti, Cr, Nb, S, Y, and W; more preferably Al, B, Ti, Nb, and W, wherein the surface layer of Zr and Si may be placed on the third surface layer and/or the third surface layer may be placed on the surface layer of Zr and Si and/or the positive electrode active layer may comprise a mixed surface layer comprising the surface layer of Zr and Si and the third surface layer.

A certain preferred embodiment concerns the positive electrode active material according to the invention,
wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0; and
having a carbon content in the range of 0.020 wt. % and 0.070 wt. % by total weight of the positive electrode active material, preferably a carbon content in the range of 0.022 wt. % and 0.060 wt. %, more preferably a carbon content in the range of 0.025 wt. % and 0.050 wt. % by total weight of the positive electrode active material.

A certain preferred embodiment concerns the positive electrode active material according to the invention,
wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0; and
having a carbon content in the range of 0.020 wt. % and 0.070 wt. % by total weight of the positive electrode active material, preferably a carbon content in the range of 0.022 wt. % and 0.060 wt. %, more preferably a carbon content in the range of 0.025 wt. % and 0.050 wt. % by total weight of the positive electrode active material.

A more certain preferred embodiment concerns the positive electrode active material according to the invention,
wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0; and
wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0; and
having a carbon content in the range of 0.020 wt. % and 0.070 wt. % by total weight of the positive electrode active material, preferably a carbon content in the range of 0.022 wt. % and 0.060 wt. %, more preferably a carbon content in the range of 0.025 wt. % and 0.050 wt. % by total weight of the positive electrode active material.

A preferred embodiment of the invention concerns the positive electrode active material according to the invention, the positive electrode active material has a Si content Si_{B}, wherein Si_{B} is expressed as molar fraction Si compared to the sum of molar fractions of Ni, Mn, Co, Si, and Zr, as measured by XPS analysis, wherein Si_{B}>0.25, preferably Si_{B}>0.5, more preferably Si_{B}>0.75. A preferred embodiment of the invention concerns the positive electrode active material according to the invention, wherein Si_{B}<5.0, preferably Si_{B}<2.0, more preferably Si_{B}<1.0. A preferred embodiment of the invention concerns the positive electrode active material according to the invention, wherein Si_{B} is in the range of 0.25 and 5.0, preferably Sis is in the range of 0.5 and 2.0, more preferably Si_{B} is in the range 0.75 and 1.0.

A preferred embodiments concerns the positive electrode active material according to the invention, wherein the positive electrode active material has a Zr content Zr_{B}, wherein Zr_{B} is expressed as molar fraction Zr compared to the sum of molar fractions of Ni, Mn, Co, Si, and Zr, as measured by XPS analysis, wherein Zr_{B}>0.25, preferably Zr_{B}>0.4, more preferably Zr_{B}>0.5. A preferred embodiment concerns concerns the positive electrode active material according to the invention, wherein Zr_{B}<2.0, preferably Zr_{B}<0.9, more preferably Zr_{B}<0.8. A preferred embodiment concerns concerns the positive electrode active material according to the invention, wherein Zr is in the range of 0.25 and 2.0, preferably Zr_{B} is in the range of 0.4 and 0.9, more preferably Zr is in the range of 0.5 and 0.8.

A certain preferred embodiment concerns the positive electrode active material according to the invention,
wherein Si_{B} is in the range of 0.25 and 5.0, preferably Si_{B} is in the range of 0.5 and 2.0, more preferably Si_{B} is in the range 0.75 and 1.0, and
wherein Zr is in a content b with b=0.0 mol %, relative to M′.

### Morphology

In certain preferred embodiments the positive electrode active material of the invention comprises single-crystalline particles. In the context of the present invention a particle is considered to be single-crystalline if it consists of only one grain or at most five grains, preferably at most three grains, as observed by Scanning Electron Microscope (SEM) or Transmission Electron Microscope (TEM), preferably by observing grain boundaries of the particle. A grain boundary is defined as the interface between two grains in a particle, preferably wherein the atomic planes of the two grains are aligned to different orientations and meet as a crystalline discontinuity.

A more certain preferred embodiment concerns the positive electrode active material according to the invention,
comprising single-crystalline particles, and
wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0.

A more certain preferred embodiment concerns the positive electrode active material according to the invention,
comprising single-crystalline particles, and
wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0.

A more certain preferred embodiment concerns the positive electrode active material according to the invention,
comprising single-crystalline particles, and
having a carbon content in the range of 0.020 wt. % and 0.070 wt. % by total weight of the positive electrode active material, preferably a carbon content in the range of 0.022 wt. % and 0.060 wt. %, more preferably a carbon content in the range of 0.025 wt. % and 0.050 wt. % by total weight of the positive electrode active material.

A more certain preferred embodiment concerns the positive electrode active material according to the invention,
comprising single-crystalline particles,
wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0, and
wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0.

A more certain preferred embodiment concerns the positive electrode active material according to the invention,
comprising single-crystalline particles,
wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0,
wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0, and
having a carbon content in the range of 0.020 wt. % and 0.070 wt. % by total weight of the positive electrode active material, preferably a carbon content in the range of 0.022 wt. % and 0.060 wt. %, more preferably a carbon content in the range of 0.025 wt. % and 0.050 wt. % by total weight of the positive electrode active material.

As appreciated by the skilled person said single-crystalline particles have said content Si_{A}, Si_{B}, Zr_{A} and/or Zr and their corresponding ratios.

In certain preferred embodiments of the invention and in the context of the present invention the single-crystalline particle as defined herein is a monolithic particle. As appreciated by the skilled person in these certain preferred embodiments all embodiments related to the single-crystalline particle equally apply to the monolithic particle as defined in the present invention.

In certain preferred embodiments the present invention provides the positive electrode active material according to the invention, wherein said positive electrode active material is a powder comprising single particles and/or secondary particles, wherein each of the single particles consist of only one primary particle and each of the secondary particles consist of at least two primary particles and at most twenty primary particles as observed in a SEM image.

Preferably, at least 30% of the particles, more preferably at least 50% of the particles, constituting the powder observed in a SEM image are the single particles and/or the secondary particles. The number of primary particles constituting the single particles and/or the secondary particles are determined in a field of view of at least 45 μm×at least 60 μm (i.e. of at least 2700 μm²), preferably of: at least 100 μm×100 μm (i.e. of at least 10,000 μm².

The particles in the image should be well distributed therefore avoiding overlap between particles. This can be achieved by pouring a small amount of powder sample to the adhesive attached on the SEM sample holder and blowing air to remove the excess powder.

In the context of the present invention primary particles are distinguished from each other in a SEM image by observing grain boundaries between the primary particles. A grain boundary is defined as the interface between two primary particles, preferably wherein the atomic planes of the two primary particles are aligned to different orientations and meet as a crystalline discontinuity.

As appreciated by the skilled person the polycrystalline particles are agglomerated by more than 20 primary particles, preferably 50 or more primary particles, more preferably 100 or more primary particles. Hence, in certain preferred embodiments said positive electrode active material is a powder comprising polycrystalline particles, wherein each of the polycrystalline particles consist of more than 20 primary particles, preferably 50 or more primary particles, more preferably 100 or more primary particle as observed in a SEM image.

Preferably, at least 30% of the particles, more preferably at least 50% of the particles, constituting the powder observed in a SEM image are polycrystalline particles. The number of primary particles constituting the polycrystalline particles are determined in a field of view of at least 45 μm×at least 60 μm (i.e. of at least 2700 μm²), preferably of: at least 100 μm×100 μm (i.e. of at least 10,000 μm². The particles in the image should be well distributed therefore avoiding overlap between particles. This can be achieved by pouring a small amount of powder sample to the adhesive attached on the SEM sample holder and blowing air to remove the excess powder.

In certain preferred embodiment, said positive electrode active material of the invention comprises polycrystalline particles. As appreciated by the skilled person the polycrystalline particles are agglomerated by 5 or more single-crystalline particles, preferably 10 or more single-crystalline particles, more preferably 50 or more single-crystalline particles. This can be observed in proper microscope techniques like Scanning Electron Microscope (SEM) by observing grain boundaries. Agglomeration of the single-crystalline particles to the polycrystalline particles occurs under a post-treatment step such as a thermal treatment step.

A more certain preferred embodiment concerns the positive electrode active material according to the invention,
comprising polycrystalline particles, and
wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0.

A more certain preferred embodiment concerns the positive electrode active material according to the invention,
comprising polycrystalline particles, and
wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0.

A more certain preferred embodiment concerns the positive electrode active material according to the invention,
comprising polycrystalline particles, and
having a carbon content in the range of 0.020 wt. % and 0.070 wt. % by total weight of the positive electrode active material, preferably a carbon content in the range of 0.022 wt. % and 0.060 wt. %, more preferably a carbon content in the range of 0.025 wt. % and 0.050 wt. % by total weight of the positive electrode active material.

A more certain preferred embodiment concerns the positive electrode active material according to the invention,
comprises polycrystalline particles,
wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0,
wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0.

A more certain preferred embodiment concerns the positive electrode active material according to the invention,
comprises polycrystalline particles,
wherein the ratio Si_{B}/Si_{A} is in the range of 100.0 and 1000.0, preferably wherein the ratio Si_{B}/Si_{A} is in the range of 200.0 and 600.0, more preferably wherein the ratio Si_{B}/Si_{A} is in the range of 250.0 and 400.0,
wherein the ratio Zr_{B}/Zr_{A} is in the range of 75.0 and 1000.0, preferably wherein the ratio Zr_{B}/Zr_{A} is in the range of 100.0 and 600.0, more preferably wherein the ratio Zr_{B}/Zr_{A} is in the range of 150.0 and 400.0, and
having a carbon content in the range of 0.020 wt. % and 0.070 wt. % by total weight of the positive electrode active material, preferably a carbon content in the range of 0.022 wt. % and 0.060 wt. %, more preferably a carbon content in the range of 0.025 wt. % and 0.050 wt. % by total weight of the positive electrode active material.

A certain preferred embodiment concerns the positive electrode active material according to the invention,
comprising polycrystalline particles,
wherein Si_{B} is in the range of 0.25 and 5.0, preferably Si_{B} is in the range of 0.5 and 2.0, more preferably Si_{B} is in the range 0.75 and 1.0, and
wherein Zr is in a content b with b=0.0 mol %, relative to M′.

As appreciated by the skilled person said polycrystalline particles have said content Si_{A}, Si_{B}, Zr_{A} and/or Zr_{B} and their corresponding ratios.

In certain preferred embodiments of the invention and in the context of the present invention the polycrystalline particle as defined herein is a secondary particle. As appreciated by the skilled person in these certain preferred embodiments all embodiments related to the polycrystalline particle equally apply to the secondary particle as defined in the present invention.

Certain preferred embodiments concern the positive electrode active material of the invention comprising single-crystalline particles having a primary particle median D50 value of less than 10 μm, preferably less than 8 μm, more preferably less than 5 μm. Certain preferred embodiments concern the positive electrode active material of the invention comprising single-crystalline particles having a primary particle median D50 value of more than 1 μm, preferably more than 2 μm, more preferably more than 3 μm. Certain preferred embodiments concern the positive electrode active material of the invention comprising single-crystalline particles having a primary particle median D50 value between 1 and 10 μm, preferably between 2 and 8 μm, more preferably between 3 and 5 μm. As appreciated by the skilled person the particle size distribution (PSD) D50 of the positive electrode active material powder is measured by laser diffraction particle size analysis. Preferably, the D50 is defined as a volume average particle size, more preferably the particle size at 50% of the cumulative volume % distributions obtained from the Malvern Mastersizer 3000 with Hydro MV measurements. For example, but not limiting to the invention, the particle median D50 can be measured using a Malvern Mastersizer 3000. Certain preferred embodiments concern the positive electrode active material of the invention comprising polycrystalline particles having a secondary particle median D50 value of less than 20 μm, preferably less than 15 μm, more preferably less than 12 μm. Certain preferred embodiments concern the positive electrode active material of the invention comprising polycrystalline particles having a secondary particle median D50 value of more than 1 μm, preferably more than 3 μm, more preferably more than 5 μm. Certain preferred embodiments concern the positive electrode active material of the invention comprising polycrystalline particles having a secondary particle median D50 value between 1 and 20 μm, preferably between 3 and 15 μm, more preferably between 5 and 12 μm. As appreciated by the skilled person the particle size distribution (PSD) D50 of the positive electrode active material powder is measured by laser diffraction particle size analysis. Preferably, the D50 is defined as as a volume average particle size, more preferably the particle size at 50% of the cumulative volume % distributions obtained from the Malvern Mastersizer 3000 with Hydro MV measurements. For example, but not limiting to the invention, the particle median D50 can be measured using a Malvern Mastersizer 3000.

In a further aspect the invention provides a secondary particles-based positive electrode active material for solid state batteries comprising Li, M′, and oxygen, wherein M′ comprises:
Ni in a content x, wherein 50.0≤x≤95.0 mol %, relative to M′,
Mn in a content y, wherein 0.0≤y≤30.0 mol %, relative to M′,
Co in a content z, wherein 0.0≤z≤30.0 mol %, relative to M′,
Si in a content a, wherein 0.01≤a≤1.5 mol %, relative to M′,
Zr in a content b, wherein 0.0≤b≤1.5 mol %, relative to M′,
D in a content d, wherein D is an element other than Li, Ni, Mn, Co, Si, Zr and oxygen; wherein 0.0≤d≤2.0 mol %, relative to M′, and,
wherein x, y, z, a, b, and d are measured by ICP-OES,
wherein x+y+z+a+b+d is 100.0 mol %,
   wherein the positive electrode active material has a Si content Si_{A} defined as a/(x+y+z+a+b), wherein the positive electrode active material has a Si content Si_{B}, wherein Si_{B} is expressed as molar fraction Si compared to the sum of molar fractions of Ni, Mn, Co, Si, and Zr, as measured by XPS analysis, wherein the ratio Si_{B}/Si_{A}>50.0.

In highly preferred embodiments of the secondary particles-based positive electrode active material, all embodiments directed to the positive electrode active material according to the first aspect of the invention apply mutatis mutandis to the secondary particles-based positive electrode active material. For example, the various embodiments relating to the identity and amounts of Li, M′, Si_{B}, Si_{A}, Zr_{A} and Zr_{B} as explained herein in the context of the positive electrode active material are equally applicable to the secondary particles-based positive electrode active material.

In a further aspect the invention provides a single-crystalline particles-based positive electrode active material for solid state batteries comprising Li, M′, and oxygen, wherein M′ comprises:
Ni in a content x, wherein 50.0≤x≤95.0 mol %, relative to M′,
Mn in a content y, wherein 0.0≤y≤30.0 mol %, relative to M′,
Co in a content z, wherein 0.0≤z≤30.0 mol %, relative to M′,
Si in a content a, wherein 0.01≤a≤1.5 mol %, relative to M′,
Zr in a content b, wherein 0.0≤b≤1.5 mol %, relative to M′,
D in a content d, wherein D is an element other than Li, Ni, Mn, Co, Si, Zr and oxygen; wherein 0.0≤d≤2.0 mol %, relative to M′, and,
wherein x, y, z, a, b, and d are measured by ICP-OES,
wherein x+y+z+a+b+d is 100.0 mol %,
   wherein the positive electrode active material has a Si content Si_{A} defined as a/(x+y+z+a+b), wherein the positive electrode active material has a Si content Si, wherein Si_{B} is expressed as molar fraction Si compared to the sum of molar fractions of Ni, Mn, Co, Si, and Zr, as measured by XPS analysis, wherein the ratio Si_{B}/Si_{A}>50.0.

In a highly preferred embodiment of the single-crystalline particles-based positive electrode active material, all embodiments directed to the positive electrode active material according to the first aspect of the invention apply mutatis mutandis to the single-crystalline particles-based positive electrode active material. For example, the various embodiments relating to the identity and amounts of Li, M′, Si_{B}, Si_{A}, Z_{A} and Zr_{B} as explained herein in the context of the positive electrode active material are equally applicable to the single-crystalline particles-based positive electrode active material.

### Method

In a second aspect the invention provides a method for manufacturing a positive electrode active material, wherein said method comprises:
preparing a slurry comprising a lithium transition metal-based oxide compound, a source of Li and an alcohol,
mixing said slurry with a source of Si and optionally a source of Zr, preferably mixing said slurry with a source of Si and a source of Zr, and
heating the mixture at a temperature between 250° C. and less than 500° C. for a time between 1 hour and 20 hours so as to obtain the positive electrode active material.

In a highly preferred embodiment of the method for manufacturing a positive electrode active material of the invention the positive electrode active material is according to the first aspect of the invention. As appreciated by the skilled person, in case the method for manufacturing a positive electrode active material of the invention affords the positive electrode material according to the first aspect of the invention, all embodiments directed to the positive electrode active material according to the first aspect of the invention apply mutatis mutandis to the method for manufacturing the positive electrode active material according to the first aspect of the invention. For example, the various embodiments relating to the identity and amounts of Li, M′, Si_{B}, Si_{A}, Zr_{A} and Zr_{B} as explained herein in the context of the positive electrode active material are equally applicable to the method for the preparation of the positive electrode active material.

In a preferred embodiment the source of Li is metallic lithium or a lithium salt, preferably a lithium salt such as LiOH.

In a preferred embodiment of the method the lithium transition metal-based oxide compound comprises Li, M″ and oxygen, wherein M″ comprises Ni, Mn, Co and D, wherein D is at least one element of the group consisting of: Al, B, Ba, Ca, Ce, Cr, Fe, La, Mg, Mo, Nb, S, Sr, Ti, V, W, Y, and Zn; preferably Al, B, Ti, Cr, Nb, S, Y, and W; more preferably Al, B, Ti, Nb, and W. Preferably, the lithium transition metal-based oxide used is also typically prepared according to a lithiation process, which is the process wherein a mixture of a transition metal oxide precursor and a further source of lithium is heated at a temperature preferably of at least 500° C. and at most 1000° C. Typically, the transition metal precursor is prepared by coprecipitation of one or more transition metal sources, such as salts, preferably sulfates or nitrates, more preferably sulfates; of the elements Ni, Mn and/or Co, in the presence of an alkali compound, such as an alkali hydroxide e.g. sodium hydroxide and/or ammonia. Preferably, the further source of lithium is metallic lithium or a lithium salt, preferably a lithium salt such as LiOH.

In a preferred embodiment the slurry further comprises water. Preferably, the amount of water in the slurry is between 0.5 mol % to 25.0 mol %, with respect to metal content in the lithium transition metal oxide compound, preferably between 0.7 mol % to 10.0 mol %, more preferably between 1 mol % to 5 mol %, with respect to metal content in the lithium transition metal oxide compound.

In a preferred embodiment of the method, the source of Zr is a Zr-alkoxide, preferably Zr-ethoxide, Zr-propoxide or Zr-butoxide, more preferably Zr-propoxide, such as Zr(IV)-propoxide. In a preferred embodiment the Zr-alkoxide is mixed as a solid with the mixture. Alternatively, and more preferably, the Zr alkoxide is mixed as a solution with the slurry, wherein the solution comprises the Zr-alkoxide and a further alcohol, wherein the alkoxide group is a conjugate base of the further alcohol. For example, the Zr-alkoxide is Zr(IV)-propoxide, which is dissolved in propanol. Typically, the solution comprises 50-90 wt. % of the Zr-alkoxide by total weight of the solution. Examples of such a solution are a 70 wt. % Zr-propoxide in 1-propanol or a 80 wt. % Zr-butoxide in 1-butanol. Preferably, the alcohol solvent is methanol, ethanol, propanol or butanol, preferably ethanol.

In a preferred embodiment the amount of Zr present in the source of Zr in the slurry is between 0.0 mol % to 1.0 mol %, with respect to metal content in the lithium transition metal-based oxide compound, preferably between 0.05 mol % and 0.75 mol %, more preferably between 0.1 mol % and 0.5 mol %, with respect to metal content in the lithium transition metal-based oxide compound.

In a preferred embodiment of the method, the source of Si is a Si-alkoxide, an alkylalkoxy silane or a polysiloxane, preferably a Si-alkoxide.

In a more highly preferred embodiment, the source of Si is a Si-alkoxide, preferably SiOR¹R²R³R⁴, wherein R¹, R², R³ and R⁴ are independently selected from H and C₁-C₈ alkyl or alkenyl optionally substituted with a halide, preferably C₁-C₄ alkyl, more preferably C₁-C₂ alkyl. In a more preferred embodiment of the method, the source of Si is a Si-alkoxide being SiOR₄⁵, wherein R⁵ is a C₁-C₈alkyl or alkenyl optionally substituted with a halide, preferably a C₁-C₄ alkyl, more preferably a C₁-C₂ alkyl. In a highly preferred the source of Si is silicon tetraethoxide.

In a preferred embodiment the source of Si is an alkylalkoxy silane, more preferably R⁶ₐ(R⁷O)_{b}Si with a=1, 2 or 3, b=1, 2 or 3, a+b=4, and R⁶ and R⁷ independently selected from the group consisting of H and C₁-C₈ alkyl or alkenyl optionally substituted with a halide, preferably a C₁-C₄ alkyl, more preferably a C₁-C₂ alkyl; more preferably R⁶ and R⁷ are the same alkyl selected from the group consisting of a C₁-C₈ alkyl or alkenyl optionally substituted with a halide, preferably a C₁-C₄ alkyl, more preferably a C₁-C₂ alkyl; most preferably the source of Si is methyltrimethoxy silane.

In a preferred embodiment the source of Si is a polysiloxane, preferably a polydialkylsiloxane, wherein the alkyl group is selected from C₁-C₈ alkyl or alkenyl optionally substituted with a halide, preferably C₁-C₄ alkyl, more preferably C₁-C₂ alkyl, more preferably a polydimethylsiloxane. In a highly preferred embodiment the source of Si is a polysiloxane being a hydroxy terminated polydimethylsiloxane or a trimethylsiloxy terminated polydimethylsiloxane, preferably a hydroxy terminated polydimethylsiloxane. The present invention is not limited to a particular polydimethylsiloxane having a specific number average molecular weight Mn. Such polymers are commercially available in a variety of different number average molecular weight. Preferably, the hydroxy terminated polydimethylsiloxane or the trimethylsiloxy terminated polydimethylsiloxane has a number average molecular weight Mn between 200 g/mol and 1 000 000 g/mol, preferably between 300 g/mol and 150 000 g/mol, most preferably between 400 g/mol and 10 000 g/mol, such as about 410 g/mol or 4200 g/mol.

A preferred embodiment of the method is the heating of the mixture under an oxidizing atmosphere. Preferably, the oxidizing atmosphere comprises oxygen, such as air, or consists of oxygen.

In a preferred embodiment of the method is the heating of the mixture at a temperature of at least 275° C., preferably at least 300° C., more preferably at least 325° C. In a preferred embodiment of the method is the heating of the mixture at a temperature of at most 450° C., preferably at most 400° C., more preferably at most 375° C. In a preferred embodiment of the method is the heating of the mixture at a temperature between 275° C. and 450° C., preferably between 300 and 400° C., more preferably between 325 and 375° C.

In a preferred embodiment of the method is the heating of the mixture at a time of at least 2 hours, preferably at least 3 hours, more preferably at least 4 hours. In a preferred embodiment of the method is the heating of the mixture at a time of at most 15 hours, preferably at most 10 hours, more preferably at most 7 hours. In a preferred embodiment of the method is the heating of the mixture at a time between 2 hours and 15 hours, preferably between 3 hours and 10 hours, more preferably between 4 hours and 7 hours.

In a preferred embodiment of the method is the heating of the mixture
at a temperature between 275° C. and 450° C., preferably between 30° and 400° C., more preferably between 325 and 375° C.; and
at a time between 2 hours and 15 hours, preferably between 3 hours and 10 hours, more preferably between 4 hours and 7 hours.

In a more preferred embodiment, the heating occurs in a furnace.

In certain preferred embodiments of the method comprises a further step, before heating said mixture, of drying said mixture. Preferably, said drying is done under vacuum, vacuum heating or under the constant flow of N₂ gas for at least 4 hours and at most 20 hours.

In certain preferred embodiments of the method, the slurry comprises water as defined herein and the method comprises a further step, before heating said mixture, of filtering and drying said mixture. Preferably, said drying is done under vacuum, vacuum heating or under the constant flow of N₂ gas for at least 4 hours and at most 20 hours. As appreciated by the skilled person, filtering of said mixture is achieved by conventional filtration techniques known in the art.

### Product-by-Process

In a third aspect the invention concerns the positive electrode active material obtainable by the method according to the second aspect of the invention. As appreciated by the skilled person all embodiments directed to the positive electrode active material according to the first aspect of the invention and/or the method according to the second aspect of the invention apply mutatis mutandis to the positive electrode active obtainable by the method according to the invention. For example, the various embodiments relating to the identity and amounts of Li, M′, Si_{A}, Si_{B}, Zr_{A}, Zr_{B}, the source of Zr and the source of Si as explained herein in the context of the positive electrode active material are equally applicable to the positive electrode active material obtainable by the method for the preparation of the positive electrode active material.

### Battery

In a fourth aspect the invention concerns a battery comprising the positive electrode active material according to the first aspect of the invention and/or the positive electrode active material obtainable by the method according to the third aspect of the invention.

In a preferred embodiment the battery is a solid-state battery. Preferably the solid-state battery comprises a sulfide-based electrolyte. Preferably said electrolyte is a sulfide-based solid electrolyte, more preferably the electrolyte comprises Li, P, and S. Typically, the following sulfur containing compounds of Li₆PS₅X with X being F, Cl, Br or I; preferably X is Cl or Br, thio-LISICON (Li_{3.25}Ge_{0.25}P_{0.75}S₄), Li₂S—P₂S₅—LiCl, Li₂S—SiS₂, LiI—Li₂S—SiS₂, Li₂S—P₂S₅—LiCl, Li₂S—SiS₂, LiI—Li₂S—SiS₂, LiI—Li₂S—P₂S₅, LiI—Li₂SP₂O₅, LiI—Li₃PO₄—P₂S₅, Li₂S—P₂S₅, Li₃PS₄, Li₇P₃S₁₁, LiI—Li₂S—B₂S₃, Li₃PO₄—Li₂S—SiS₂, Li₃PO₄—Li₂S—SiS₂, Li₃PO₄—Li₂S—SiS₂, Li₁₀GeP₂S₁₂, Li_{9.54}Si_{1.74}P_{1.44}S_{11.7}Cl_{0.3}, and/or Li₇P₃S₁₁ may be suitably used. In a highly preferred embodiment, the battery is a sulfide solid-state battery.

Preferably, the solid-state battery further comprises an anode comprising anode active material. Suitable electrochemically active anode materials are those known in the art. For example, the anode may comprise graphitic carbon, metallic lithium or a metal alloy comprising lithium, such as Li—In alloy, as the anode active material.

In a preferred embodiment the battery according to the invention has a first discharge capacity of at least 175 mAh/g, more preferably of at least 180 mAh/g, more preferably of at least 185 mAh/g, most preferably of at least 190 mAh/g. As understood by the skilled person the first discharge capacity (DQ1) is measured in constant current mode (CC) at C rate of 0.1 C in voltage range: 4.3 V to 2.5 V (Li/Li⁺) or 3.7 V to 1.9 V (InLi/Li⁺).

In a preferred embodiment the battery according to the invention has an efficiency of at least 88%, preferably at least 90%, more preferably at least 92%. As appreciated by the skilled person the efficiency of the battery is determined, wherein the initial charge capacity (CQ1) and discharge capacity (DQ1) are measured in constant current mode (CC) at C rate of 0.1 C in voltage range from 4.3 V to 2.5 V (Li/Li+) or from 3.7 V to 1.9 V (In—Li/Li+). The efficiency (%) of the reversible capacity is obtained according to an equation below:

$$Efficiency ( \% ) = \frac{D Q 1}{C Q 1} \times 100 ( \% ) .$$

Preferably, the schedule uses a 1 C current definition of 160 mA/g.

### Use

In a fifth aspect the present invention concerns a use of the positive electrode active material according to the first aspect of the invention and/or the positive electrode active material obtainable by the method according to the third aspect of the invention in a battery.

A preferred embodiment is the use of the positive electrode active material in a battery, preferably a solid-state-battery, more preferably a sulfide solid-state-battery, to increase the efficiency of said battery and/or to increase the first discharge capacity of said battery.

In a sixth aspect the present invention concerns a use of the battery according to invention in either one of a portable computer, a tablet, a mobile phone, an energy storage system, an electric vehicle or in a hybrid electric vehicle, preferably in an electric vehicle or in a hybrid electric vehicle.

### EXAMPLES

### Experimental Analysis Used in the Examples

The following analysis methods are used in the Examples.

### A) Inductively Coupled Plasma Optical Emission Spectrometry (ICP-OES) Measurement

The amount of Li, Ni, Co, Mn, Si and Zr in the positive electrode active material powder is measured with the inductively coupled plasma-optical emission spectrometry (ICP-OES) method by using an Agillent ICP 720-ES (Agilent Technologies). 2 grams of powder sample is dissolved into 10 mL of high purity hydrochloric acid (at least 37 wt % of HCl with respect to the total weight of solution) in an Erlenmeyer flask. The flask is covered by a glass and heated on a hot plate at 380° C. until complete dissolution of the precursor. After being cooled to room temperature, the solution of the Erlenmeyer flask is poured into a 250 ml volumetric flask. Afterwards, the volumetric flask is filled with deionized water up to the 250 ml mark, followed by complete homogenization. Another suitable solvent can be used to fully dissolve the positive electrode active material powder samples.

### B) X-Ray Photoelectron Spectroscopy (XPS) Measurement

The surface of the positive electrode active material is analyzed by using X-ray photoelectron spectroscopy (XPS). In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of positive electrode active material powder particles, XPS measurement is carried out using a Thermo K-α+ spectrometer. Monochromatic Al Kα radiation (hv=1486.6 eV) is used with a spot size of 400 μm and measurement angle of 45°.

A wide survey scan to identify elements present at the surface is conducted at 200 eV pass energy. C1s peak having a maximum intensity (or centered) at a binding energy of 284.8 eV is used as a calibrate peak position after data collection. Accurate narrow-scans are performed afterwards at 50 eV for at least 10 scans for each identified element to determine the precise surface composition.

Curve fitting is done with CasaXPS Version2.3.19PR1.0 (Casa Software) using a Shirley-type background treatment and Scofield sensitivity factors. The fitting parameters are according to Table 2a. Line shape GL(30) is the Gaussian/Lorentzian product formula with 70% Gaussian line and 30% Lorentzian line. LA(α, β, m) is an asymmetric line-shape where α and β define tail spreading of the peak and m define the width.

TABLE 1a
XPS fitting parameter for Ni2p, Mn2p, Co2p, Si2p, and Zr3d.

| | Sensitivity | Fitting range | | |
|---|---|---|---|---|
| Element | factor | (eV) | Defined peak(s) | Line shape |
| Ni | 14.61 | 851.1 ± 0.1- | Ni2p3, Ni2p3 | LA |
| | | 869.4 ± 0.1 | satellite | (1.33, 2.44, 69) |
| Mn | 9.17 | 639.9 ± 0.1- | Mn2p3, Mn2p3 | GL(30) |
| | | 649.5 ± 0.1 | satellite | |
| Co | 12.62 | 775.4 ± 0.1- | Co2p3-1, Co2p3-2, | GL(30) |
| | | 792.7 ± 0.3 | Co2p3 satellite | |
| Si | 0.817 | 98.4 ± 0.1- | Si2p | GL(30) |
| | | 104.1 ± 0.1 | | |
| Zr | 7.04 | 178.3 ± 0.1- | Zr3d3, Zr3d1 | GL(30) |
| | | 188.6 ± 0.1 | | |

For Mn, Co, and Zr peaks, constraints are set for each defined peak according to Table 1b.

TABLE 1b
XPS fitting Constraints for Mn2p, Co2p, and Zr3d.

| | | Fitting range | FWHM | |
|---|---|---|---|---|
| | | constraint | constraint | |
| Element | Defined peak | (eV) | (eV) | Area constraint |
| Mn | Mn2p3 peak | 640-644 | 0.1-3.5 | No constraint set |
| | Mn2p3 peak | 644-647 | Equal to Mn2p3 | 50% of Mn2p3 |
| | satellite | | | peak area |
| Co | Co2p3-1 | 776.0-780.9 | 0.5-4.0 | No constraint set |
| | Co2p3-2 | 781.0-785.0 | 0.5-4.0 | No constraint set |
| | Co2p3 satellite | 785.1-792.0 | 0.5-6.0 | No constraint set |
| Zr | Zr3d1 | 183.0-186.0 | Equal to Zr3d3 | 66.7% of Zr3d3 |
| | Zr3d3 | 180.0-183.0 | 0.5-4.0 | No constraint set |

The surface content of Si and the surface content of Zr as determined by XPS are expressed as a molar fraction of Si and a molar fraction of Zr in the surface layer of the particles divided by the total content of Ni, Co, Mn, Si, and Zr in said surface layer. They are calculated as follow:

$$Fraction of Si = {Si}_{B} = \frac{Si ( at \% )}{Ni ( at \% ) + Co ( at \% ) + Mn ( at \% ) + Si ( at \% ) + Zr ( at \% )} ,$$

$$Fraction of Zr = {Zr}_{B} = \frac{Zr ( at \% )}{Ni ( at \% ) + Co ( at \% ) + Mn ( at \% ) + Si ( at \% ) + Zr ( at \% )} .$$

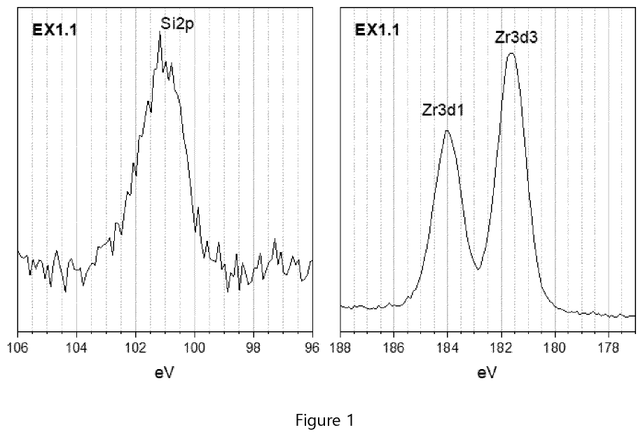

The information of XPS peak position can be easily obtained in the regions and components report specification after fitting is conducted. XPS graph of Si and Zr for EX1.1 is shown in FIG. 1.

### C) Carbon Analysis

The content of carbon of the positive electrode active material powder is measured by Horiba Emia-Expert carbon/sulfur analyzer. 1 gram of the positive electrode active material powder is placed in a ceramic crucible in a high frequency induction furnace. 1.5 grams of tungsten and 0.2 grams of tin are added into the crucible as accelerators. The powder is heated at a programmable temperature wherein gases produced during the combustion are then analyzed by Infrared detectors. The analysis of CO₂ and CO determines the carbon concentration.

### D) Sulfide Solid-State Rechargeable Battery Test

### D-1) Sulfide Solid-State Rechargeable Battery Preparation

### Positive Electrode Preparation:

For the preparation of a positive electrode, a slurry contains positive electrode active material powder, Li—P—S based solid electrolyte, carbon (Super-P, Timcal), and binder (RC-10, Arkema)—with a formulation of 64.0:30.0:3.0:3.0 by weight—in butyl acetate solvent is mixed in Ar-filled glove box. The slurry is casted on one side of an aluminum foil followed by drying the slurry coated foil in a vacuum oven to obtain a positive electrode. The obtained positive electrode is punched with a diameter of 10 nm wherein the active material loading amount is around 4 mg/cm².

### Negative Electrode Preparation:

For the preparation of a negative electrode, Li foil (diameter 3 mm, thickness 100 μm) is placed centered on the top of In foil (diameter 10 nm, thickness 100 μm) and pressed to form Li—In alloy negative electrode.

### Separator Preparation:

For the preparation of a separator which also has a function of the solid electrolyte in a battery, the Li—P—S based solid electrolyte is pelletized with a pressure of 250 MPa to obtain 100 μm pellet thickness.

### Cell Assembly:

A sulfide solid-state rechargeable battery is assembled in an Ar-filled glovebox with such order from bottom to top: positive electrode comprising Al current collector with the coated part on the top—separator—negative electrode with Li side on the top—Cu current collector. The stacked components are pressed together with a pressure of 250 MPa and placed in an external cage to prevent air exposure.

### D-2) Testing Method

The testing method is a conventional “constant cut-off voltage” test. The conventional cell test in the present invention follows the schedule shown in Table 2. Each cell is cycled at 60° C. using a Toscat-3100 computer-controlled galvanostatic cycling station (from Toyo).

The schedule uses a 1 C current definition of 160 mA/g. The initial charge capacity (CQ1) and discharge capacity (DQ1) are measured in constant current mode (CC) at C rate of 0.1 C in voltage range from 4.3 V to 2.5 V (Li/Li⁺) or from 3.7 V to 1.9 V (In—Li/Li⁺). The efficiency (%) of the reversible capacity is obtained according to an equation below:

$$Efficiency ( \% ) = \frac{D Q 1}{C Q 1} \times 100 ( \% ) .$$

The present invention is further illustrated in the following examples.

### Comparative Example 1

A positive electrode active material CEX1 is obtained through following steps:
1) Preparing a mixture: 100.00 grams of Ni_{0.64}Co_{0.20}Mn_{0.16}(OH)₂ and 26.77 grams of anhydrous LiOH are mixed homogeneously to obtain a mixture.
2) First heating: The mixture prepared from step 1) is heated at 830° C. for 10 hours under O₂ atmosphere and cooled to room temperature.
3) Preparing a metal solution: 1.01 grams of zirconium (IV) propoxide (70.0 wt. % Zr-propoxide in n-propanol solution) is dissolved in 3 grams of ethanol.
4) Preparing a slurry: 70.00 grams of the first heated material, 26.00 grams of ethanol, 0.19 grams of deionized water, and 0.10 grams of LiOH are mixed homogeneously to obtain a slurry.
5) Preparing a wet mixture: The metal solution prepared from step 3) and the slurry prepared from step 4) are mixed and stirred for 15 hours, and then, filtered.
6) Second heating: The wet mixture prepared from step 5) is heated at 350° C. for 5 hours with an increasing rate of 5° C./min under O₂ atmosphere. The second heated material is cooled to room temperature, crushed, and sieved so as to obtain a positive electrode active material CEX1.

### Example 1.1

A positive electrode active material EX1.1 is obtained through following steps:
1) Preparing a mixture: 100.00 grams of Ni_{0.64}Co_{0.20}Mn_{0.16}(OH)₂ and 26.77 grams of anhydrous LiOH are mixed homogeneously to obtain a mixture.
2) First heating: The mixture prepared from step 1) is heated at 830° C. for 10 hours under O₂ atmosphere and cooled to room temperature.
3) Preparing a metal solution: 0.76 grams of zirconium (IV) propoxide (70.0 wt. % Zr-propoxide in n-propanol solution) and 0.11 grams of silicon tetraethoxide are dissolved in 3 grams of ethanol.
4) Preparing a slurry: 70.00 grams of the first heated material, 26.00 grams of ethanol, 0.19 grams of deionized water, and 0.10 grams of LiOH are mixed homogeneously to obtain a slurry.
5) Preparing a wet mixture: The metal solution prepared from step 3) and the slurry prepared from step 4) are mixed and stirred for 15 hours, and then, filtered.
6) Second heating: The wet mixture prepared from step 5) is heated at 350° C. for 5 hours with an increasing rate of 5° C./min under O₂ atmosphere. The second heated material is cooled to room temperature, crushed, and sieved so as to obtain a positive electrode active material EX1.1.

### Example 1.2

A positive electrode active material EX1.2 is prepared according to the same method as EX1.1 except that 0.51 grams of zirconium (IV) propoxide and 0.22 grams of silicon tetraethoxide are used to prepare a metal solution in step 3).

### Example 1.3

A positive electrode active material EX1.3 is prepared according to the same method as EX1.1 except that 0.45 grams of silicon tetraethoxide is used to prepare a metal solution in step 3).

### Example 2.1

A positive electrode active material 2.1 is obtained through following steps:
1) Preparing a mixture: 100.00 grams of Ni_{0.64}Co_{0.20}Mn_{0.16}(OH)₂ and 26.77 grams of anhydrous LiOH are mixed homogeneously to obtain a mixture.
2) First heating: The mixture prepared from step 1) is heated at 830° C. for 10 hours under O₂ atmosphere and cooled to room temperature.
3) Preparing a metal solution: 0.51 grams of zirconium (IV) propoxide (70.0 wt. % Zr-propoxide in n-propanol solution) and 0.22 grams of silicon tetraethoxide are dissolved in 3 grams of ethanol.
4) Preparing a slurry: 70.00 grams of the first heated material, 26.00 grams of ethanol, and 0.10 grams of LiOH are mixed homogeneously to obtain a slurry.
5) Preparing a second mixture: The metal solution prepared from step 3) and the slurry prepared from step 4) are mixed and stirred for 15 hours. The mixed slurry is evaporated to obtain a second mixture.
6) Second heating: The second mixture prepared from step 5) is heated at 350° C. for 5 hours with an increasing rate of 5° C./min under O₂ atmosphere. The second heated material is cooled to room temperature, crushed, and sieved so as to obtain a positive electrode active material EX2.1.

### Example 2.2

A positive electrode active material EX2.2 is prepared according to the same method as EX2.1 except that 0.45 grams of silicon tetraethoxide is used to prepare a metal solution in step 3).

### Comparative Example 2

A positive electrode active material CEX2 is obtained through following steps:
1) First mixing: 100.00 grams of Ni_{0.64}Co_{0.20}Mn_{0.16}(OH)₂ and 26.77 grams of anhydrous LiOH are mixed homogeneously to obtain a first mixture.
2) First heating: The first mixture prepared from step 1) is heated at 830° C. for 10 hours under O₂ atmosphere and cooled to room temperature.
3) Second mixing: 100.00 grams of the first heated material and 0.19 grams of SiO₂ are mixed homogeneously to obtain a second mixture.
4) Second heating: The second mixture prepared from step 2) is heated at 700° C. for 10 h with a heating rate of 5° C./min until it reaches 350° C. and a heating rate of 2° C./min until it reaches 700° C. The second heated material is cooled to room temperature, ground, and sieved so as to obtain a positive electrode active material CEX2.

### Comparative Example 3.1

A positive electrode active material CEX3.1 is obtained through following steps:
1) First mixing: 100.00 grams of Ni_{0.64}Co_{0.20}Mn_{0.16}(OH)₂ and 26.77 grams of anhydrous LiOH are mixed homogeneously to obtain a first mixture.
2) First heating: The first mixture prepared from step 1) is heated at 830° C. for 10 hours under O₂ atmosphere and cooled to room temperature.
3) Second mixing: 100.00 grams of the first heated material and 0.77 grams of ZrO₂ are mixed homogeneously to obtain a second mixture.
4) Second heating: The second mixture prepared from step 2) is heated at 850° C. for 6 hours and cooled to room temperature. The cooled material is ground and sieved so as to obtain a positive electrode active material CEX3.1.

### Comparative Example 3.2

A positive electrode active material CEX3.2 is prepared according to the same method as CEX3.1 except that 0.30 grams of LiOH is added while second mixing to prepare a second mixture in step 3).

TABLE 3
A summary of the chemical composition, Si_{B}/Si_{A} ratio, and Zr_{B}/Zr_{A}, and carbon content

| | Composition* (mol %) from ICP-OES | | | | | | | | | |
|---|---|---|---|---|---|---|---|---|---|---|
| | Ni | Mn | Co | Si | Zr | | | | | C |
| ID | (x) | (y) | (z) | (a) | (b) | Si_{B}** | Zr_{B}** | Si_{B}/Si_{A}*** | Zr_{B}/Zr_{A}*** | (ppm) |
| CEX1 | 63.5 | 16.4 | 19.8 | 0.00 | 0.30 | 0.0 | 0.98 | n/a**** | 326.7 | 424 |
| EX1.1 | 63.5 | 16.4 | 19.8 | 0.075 | 0.225 | 0.27 | 0.69 | 360.0 | 306.7 | 360 |
| EX1.2 | 63.5 | 16.4 | 19.8 | 0.15 | 0.15 | 0.52 | 0.42 | 346.7 | 280.0 | 333 |
| EX1.3 | 63.5 | 16.4 | 19.8 | 0.30 | 0.00 | 0.92 | 0.0 | 306.7 | n/a | 293 |
| EX2.1 | 63.5 | 16.4 | 19.8 | 0.15 | 0.15 | 0.40 | 0.28 | 266.7 | 186.7 | 468 |
| EX2.2 | 63.5 | 16.4 | 19.8 | 0.30 | 0.00 | 0.76 | 0.0 | 253.3 | n/a | 459 |
| CEX2 | 64.1 | 16.1 | 19.6 | 0.28 | 0.00 | 0.76 | 0.0 | 272.8 | n/a | 357 |
| CEX3.1 | 64.0 | 16.0 | 19.5 | 0.00 | 0.57 | 0.0 | 0.26 | n/a | 45.4 | 314 |
| CEX3.2 | 64.0 | 16.1 | 19.4 | 0.00 | 0.57 | 0.0 | 0.26 | n/a | 45.0 | 336 |

*Composition relative to total molar contents of Ni, Co, Mn, Si, and Zr
**Si_{B} or Zr_{B} is the molar fraction of Si or Zr with respect to total molar contents of Ni, Mn, Co, Si, and Zr analyzed by XPS
***Si_{A} or Zr_{A} is the molar fraction of Si or Zr with respect to total molar contents of Ni, Mn, Co, Si, and Zr analyzed by ICP-OES
****n/a: not available

TABLE 4
A summary of the electrochemical properties

| | Electrochemical property | |
|---|---|---|
| Example ID | DQ1 (mAh/g) | Efficiency (%) |
| CEX1 | 174.6 | 88.6 |
| EX1.1 | 190.6 | 92.3 |
| EX1.2 | 183.7 | 90.4 |
| EX1.3 | 178.3 | 88.3 |
| EX2.1 | 192.5 | 90.6 |
| EX2.2 | 185.3 | 90.8 |
| CEX2 | 173.8 | 84.9 |
| CEX3.1 | 170.3 | 86.1 |
| CEX3.2 | 166.1 | 86.4 |

Table 3 summarizes the chemical compositions, Si_{B}/Si_{A} ratio, and Zr_{B}/Zr_{A}, carbon content of all examples and comparative examples. Table 4 summarizes the electrochemical properties such as the first discharge capacity DQ1 and efficiency for the examples and comparative examples.

In Table 3, the XPS analysis results of Si (Si_{B}) and Zr (Zr_{B}) are compared with the ICP-OES results of Si (Si_{A}) and Zr (Zr_{A}) for CEX1, EX1.1, EX1.2, EX1.3, EX2.1, and EX2.2. The Si_{B} or Zr_{B} result higher than 0 indicates that said Si or Zr is present on the surface of the positive electrode active material as associated with the XPS measurement whose signal is acquired from the first few nanometers (e.g. 1 nm to 10 nm) of the uppermost part of a sample. On the other hand, Si_{A} and Zr_{A} from ICP-OES measurement are the Si content and Zr content of the entire particle. Therefore, the ratio of XPS result to ICP-OES result such as Si_{B}/Si_{A} and Zr_{B}/Zr_{A} higher than 1 indicates that said Si and Zr are present mostly on the surface of the positive electrode active material. The higher Si_{B}/Si_{A} value or Zr_{B}/Zr_{A} value corresponds with the more Si or Zr presence on the surface of positive electrode active material. The representative of XPS spectra showing Si peak and Zr peak of EX1.1 is in FIG. 1.

The positive electrode active material EX1.1 comprises 0.075 mol % Si and 0.225 mol % Zr with respect to total molar contents of Ni, Mn, Co, Si, and Zr. The Si_{B}/Si_{A} value and Zr_{B}/Zr_{A} value of EX1.1 are 360.0 and 306.7, respectively, which confirms the Si and Zr presence on the surface of the particle according to this invention. The positive electrode active material CEX1 comprises 0.30 mol % Zr with respect to total molar contents of Ni, Mn, Co, Si, and Zr while CEX1 does not comprise Si. The solid-state rechargeable battery comprising EX1.1 has a DQ1 value of 190.6 mAh/g which is higher than the DQ1 value of the battery comprising CEX1 as 174.6 mAh/g. Besides, the efficiency of the battery comprising EX1.1 is 92.3%, while the efficiency of the battery comprising CEX1 is 88.6%, which indicates that the battery comprising EX1.1 has the improved electrochemical stability. The positive electrode active material EX1.2 and EX2.1 comprise 0.15 mol % Si and 0.15 mol % Zr with respect to total molar contents of Ni, Mn, Co, Si, and Zr. The Si_{B}/Si_{A} values of EX1.2 and EX2.1 are 346.7 and 266.7, respectively, and the Zr_{B}/Zr_{A} values of EX1.2 and EX2.1 are 280.0 and 186.7, respectively, which confirms that the Si and Zr presence on the surface of EX1.2 and EX2.1 according to this invention. The DQ1 value and the efficiency of the battery comprising EX1.2 are 183.7 mAh/g and 90.4% respectively, and the DQ1 value and the efficiency of the battery comprising EX2.1 are 192.5 mAh/g and 90.6% respectively. The DQ1 values and the efficiencies of the batteries comprising EX1.2 or EX2.1 are higher than the DQ1 value and the efficiency of the battery comprising CEX1, which indicates the battery comprising EX1.2 or EX2.1 has the higher initial capacity and the improved electrochemical stability.

Both positive electrode active material EX1.3 and EX2.2 comprise 0.30 mol % Si with respect to total molar contents of Ni, Mn, Co, Si, and Zr. The DQ1 value of the solid-state battery comprising EX1.3 is 178.3 mAh/g which is higher than the DQ1 of the battery comprising CEX1 and the efficiency is 88.3% which is similar to that of the battery comprising CEX1. The DQ1 value of the battery comprising EX2.2 is 185.3 mAh/g and the efficiency is 90.8%, which are both improved from the battery comprising CEX1.

A positive electrode active material CEX2 comprises 0.28 mol % Si relative to total molar contents of Ni, Mn, Co, Si, and Zr analyzed by ICP-OES, which is similar Si content with EX2.2. The Si_{B}/Si_{A} value of CEX2 is 272.8 and the Si_{B}/Si_{A} value of EX2.2 is 253.3, wherein CEX2 was prepared by dry mixing with SiO₂ and EX2.2 was obtained by mixing with the slurry comprising Si containing solution.

It is obviously observed that Si presence on the surface of the particle, optionally with Zr presence, which has Si_{B}/Si_{A} higher than 50.0, especially prepared by mixing the slurry comprising a lithium transition metal-based oxide, Li, and an alcohol and the Si containing solution, can achieve the object of the present invention, which is to provide a positive electrode active material having an improved first discharge capacity, and an improved efficiency.

1-15. (canceled)

16. A positive electrode active material for solid state batteries comprising Li, M′, and oxygen, wherein M′ comprises:
Ni in a content x, wherein 50.0≤x≤95.0 mol %, relative to M′,
Mn in a content y, wherein 0.0≤y≤30.0 mol %, relative to M′,
Co in a content z, wherein 0.0≤z≤30.0 mol %, relative to M′,
Si in a content a, wherein 0.01≤a≤1.5 mol %, relative to M′,
Zr in a content b, wherein 0.0≤b≤1.5 mol %, relative to M′,
D in a content d, wherein D is an element other than Li, Ni, Mn, Co, Si, Zr and oxygen; wherein 0.0≤d≤2.0 mol %, relative to M′, and,
wherein x, y, z, a, b, and d are measured by ICP-OES,
wherein x+y+z+a+b+d is 100.0 mol %,
wherein the positive electrode active material has a Si content Si_{A} defined as a/(x+y+z+a+b), wherein the positive electrode active material has a Si content Sip, wherein Si_{B} is expressed as molar fraction Si compared to the sum of molar fractions of Ni, Mn, Co, Si, and Zr, as measured by XPS analysis, wherein the ratio Si_{B}/Si_{A}>50.0.

17. The positive electrode active material according to claim 16, wherein 0.0 mol %<b≤1.0 mol %.

18. The positive electrode active material according to claim 16, wherein the positive electrode active material has a Zr content Zr_{A} defined as b/(x+y+z+a+b),
wherein the positive electrode active material has a Zr content Zr_{B} wherein Zr_{B} is expressed as molar fraction Zr compared to the sum of molar fractions of Ni, Mn, Co, Si, and Zr, as measured by XPS analysis, wherein the ratio Zr_{B}/Zr_{A}>50.0.

19. The positive electrode active material according to claim 16, wherein Sip/Si_{A}>100.0 and Zr_{B}/Zr_{A}>100.0.

20. The positive electrode active material according to claim 16, wherein 55.0≤x≤90.0 mol %, relative to M′.

21. The positive electrode active material according to claim 16, wherein 0.03 mol %<a≤1.0 mol %.

22. The positive electrode active material according to claim 16, wherein D is at least one element selected from the group consisting of Al, B, Ba, Ca, Ce, Cr, Fe, La, Mg, Mo, Nb, S, Sr, Ti, V, W, Y, and Zn.

23. The positive electrode active material according to claim 16 comprising polycrystalline particles.

24. The positive electrode active material according to claim 23, wherein the secondary particle median size D50 is between 1 μm and 20 μm, as determined by laser diffraction particle size analysis.

25. A method for manufacturing a positive electrode active material, wherein said method comprises:
preparing a slurry comprising a lithium transition metal-based oxide compound, a source of Li, and an alcohol,
mixing said slurry with a source of Si and optionally a source of Zr, and
heating the mixture at a temperature between 250° C. and less than 500° C. for a time between 1 hour and 20 hours so as to obtain the positive electrode active material.

26. The method according to claim 25, comprising mixing said slurry with a source of Si and a source of Zr, wherein the source of Zr is a Zr-alkoxide.

27. The method according to claim 25, wherein the source of Si is a Si-alkoxide, an alkylalkoxy silane, or a polysiloxane.

28. A solid-state battery comprising the positive electrode active material according to claim 16.

29. The solid-state battery according to claim 28, wherein said solid-state battery comprises a sulfide-based solid electrolyte comprising Li, P, and S.

30. A portable computer, a tablet, a mobile phone, an energy storage system, an electric vehicle, or a hybrid electric vehicle comprising the solid-state battery according to claim 28.
